(19) United States
(12) Patent Application Publication
(10) Pub. No.: US 2023/0339566 A1
(43) Pub. Date: Oct. 26, 2023

(54) VEHICLE

(71) Applicants: Vijay K PRAVEEN, Bangalore (IN); Alok DAS, Pune (IN)

(72) Inventors: Vijay K PRAVEEN, Bangalore (IN); Alok DAS, Pune, IN (US); Lakshmish GANGADHAR, Bangalore, IN (US)

(21) Appl. No.: 18/025,659

(22) PCT Filed: Sep. 10, 2021
(86) PCT No.: PCT/IB2021/058240

§ 371 Date: Mar. 10, 2023

(30) Foreign Application Priority Data
Sep. 10, 2021 (IN) 202041039099

(51) Int. Cl. B62K 7/04; B60K 11/08; B60K 1/04

(52) U.S. Cl. CPC B62K 7/04; B60K 11/08; B60K 1/04; B60K 2001/0422; B60K 2001/005

(57) ABSTRACT

A vehicle includes a frame having a plurality of structural elements coupled with each other to define a compartment adapted to accommodate a cargo; at least one energy unit compartment positioned on one of the plurality of structural elements, the at least one energy unit compartment adapted to accommodate at least Energy unit of the vehicle; and a thermal management system adapted to maintain a temperature of the at least one energy unit compartment. The thermal management system comprises at least one inlet fluid passage/channel and adapted to allow a flow of fluid from the ambient environment towards the at least one energy unit compartment. The at least one energy unit compartment is exposed to the flow of fluid entering through the at least one inlet fluid passage/channel; and at least one outlet fluid passage/channel mounted on at least one of the plurality of structural elements.

### TECHNICAL FIELD

The embodiments herein are generally related to the field of transportation. The embodiments herein are particularly related to a vehicle adapted to be ridden, and used for transportation of goods from one location to another. The embodiments herein are more particularly related to a fluid distribution system for a cargo carrying wheeled vehicle.

### BACKGROUND

Human powered freight vehicles, such as freight bicycles, carrier cycles, freight tricycles, cargo bikes, box bikes, or cycle-trucks are designed and constructed specifically for transporting loads. These vehicles find application in various settings for example, delivery services in dense urban environments, food vending in high foot traffic areas (including specialist ice cream bikes); transporting trade tools, including around large installations such as power stations and CERN, airport cargo handling etc.

Typically, these vehicles include a cargo area consisting of an open or enclosed box, a flat platform, or a wire basket, usually mounted over one or both wheels, low behind the front wheel, or between parallel wheels at either the front or rear of the vehicle. Typically, this cargo area is randomly placed and does not tend to work well with the vehicle's maneuverability since a variety of moments act on these randomly aligned vehicles; especially while taking turns, causing dangerous as well as difficult maneuvers.

Moreover, since these vehicles are human powered, their ability to carry loads, and the speed of transportation tends to be limited by human capabilities. In addition, in most of these vehicles, the loading is carried out at higher location. Therefore, in loaded state, the centre of gravity of these vehicles tends to be higher which negatively impacts the handling and dynamics of the vehicle.

Furthermore, in all prior art two-wheeled vehicles, there is often no dedicated cargo compartment for carrying load. Even if there is, in one type of modified two wheeled vehicles, the load is positioned at a relatively higher location when compared with the natural centre of gravity of the vehicle (without the modification to carry load), which effectively raises the centre of gravity to a dangerous height, making the vehicle (when loaded with rider and load) wobbly and difficult to balance and steer.

Additionally, if the load/cargo is kept behind the rider, it almost always rests against the back of the rider, thereby restricting backward movement of the rider and causing tremendous strain on the rider's back. In another type of modified two-wheeled vehicles, the load is at an operative forward location when compared with the rider. This effectively moves the centre of gravity way too ahead with respect to a rider and with respect to the entire loaded vehicles, as a whole, making maneuverability difficult.

The above-mentioned shortcomings, disadvantages and problems are addressed herein, which will be understood by studying the following specifications.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

According to one aspect of the present disclosure, a vehicle is provided. The vehicle comprises a frame comprising a plurality of structural elements coupled with each other to define a compartment adapted to accommodate a cargo; at least one energy unit compartment positioned on one of the plurality of structural elements, the at least one energy unit compartment adapted to accommodate at least energy unit of the vehicle; and a thermal management system adapted to maintain a temperature of the at least one energy unit compartment. The thermal management system comprises at least one inlet fluid passage/channel mounted on at least one of the plurality of structural elements and adapted to allow a flow of fluid from the ambient environment towards the at least one energy unit compartment, wherein the at least one energy unit compartment is exposed to the flow of fluid entering through the at least one inlet fluid passage/channel; and at least one outlet fluid passage/channel mounted on at least one of the plurality of structural elements and positioned downstream with respect to the at least one energy unit compartment, wherein the at least one outlet fluid passage/channel is adapted to allow egress of the flow of fluid from the vehicle.

The plurality of structural elements comprises at least one front structural member, at least one rear structural member, at least one bottom structural member, and at least one top structural member. The vehicle further comprising a handlebar adapted to be operated to control a direction of traversing of the vehicle, wherein the handlebar is positioned longitudinally spaced apart from a steering axis of the vehicle.

In an embodiment, the at least one energy unit compartment is mounted on the at least one rear structural member; a first inlet fluid passage/channel of the thermal management system is positioned on the at least one top structural member, the first inlet fluid passage/channel comprises an inlet located at a front end of the vehicle; a second inlet fluid passage/channel of the thermal management system is positioned on the at least one bottom structural member, the second inlet fluid passage/channel comprises an inlet located at a front end of the vehicle; and the at least one outlet fluid passage/channel positioned rearward with respect to the compartment and below the top support member of the rider supporting structure, wherein the first inlet fluid passage/channel and the second inlet fluid passage/channel are adapted to allow a flow of fluid through a front end of the vehicle towards the at least one energy unit compartment, and the at least one outlet fluid passage/channel is adapted to egress the flow of fluid flowing through a rear end of the vehicle.

In another embodiment, the at least one energy unit compartment is mounted on the at least one rear structural member; an inlet fluid passage/channel of the thermal management system is positioned on the at least one top structural member, the inlet fluid passage/channel comprises an inlet located at a front end of the vehicle; and the at least one outlet fluid passage/channel positioned rearward with respect to the compartment and below the top support member of the rider supporting structure, wherein the first inlet fluid passage/channel is adapted to allow a flow of fluid through a front end of the vehicle towards the at least one energy unit compartment, and the at least one outlet fluid passage/channel is adapted to egress the flow of fluid flowing through a rear end of the vehicle.

In another embodiment, the at least one energy unit compartment is mounted on the at least one rear structural member; an inlet fluid passage/channel of the thermal management system is positioned on the at least one bottom structural member, the inlet fluid passage/channel comprises an inlet located at a front end of the vehicle; and the at least one outlet fluid passage/channel positioned rearward with respect to the compartment and below the top support member of the rider supporting structure, wherein the inlet fluid passage/channel is adapted to allow a flow of fluid through a front end of the vehicle towards the at least one energy unit compartment, and the at least one outlet fluid passage/channel is adapted to egress the flow of fluid flowing through a rear end of the vehicle.

In another embodiment, the at least one energy unit compartment is mounted on the at least one rear structural member; an inlet fluid passage/channel of the thermal management system is positioned on the at least one rear structural member; and the at least one outlet fluid passage/channel positioned rearward with respect to the compartment and below the top support member of the rider supporting structure, wherein the inlet fluid passage/channel is adapted to allow a flow of fluid from the ambient environment towards the at least one energy unit compartment, and the at least one outlet fluid passage/channel is adapted to egress the flow of fluid flowing through a rear end of the vehicle.

In another embodiment, the at least one energy unit compartment is mounted on the at least one rear structural member; an inlet Fluid passage/channel of the thermal management system is positioned on the at least one bottom structural member, wherein the inlet fluid passage/channel comprises an inlet located on a top portion; and the at least one outlet fluid passage/channel positioned rearward with respect to the compartment and below the top support member of the rider supporting structure, wherein the inlet fluid passage/channel is adapted to allow a flow of fluid from the ambient environment towards the at least one energy unit compartment, and the at least one outlet fluid passage/channel is adapted to egress the flow of fluid flowing through a rear end of the vehicle.

In another embodiment, the at least one energy unit compartment is mounted on the at least one rear structural member; an inlet fluid passage/channel of the thermal management system is positioned on the at least one top structural member, wherein the inlet fluid passage/channel comprises an inlet located on a rear portion of the at least one top structural member; and the at least one outlet fluid passage/channel positioned rearward with respect to the compartment and below the top support member of the rider supporting structure, wherein the inlet fluid passage/channel is adapted to allow a flow of fluid from the ambient environment towards the at least one energy unit compartment, and the at least one outlet fluid passage/channel is adapted to egress the flow of fluid flowing through a rear end of the vehicle.

In another embodiment, the at least one energy unit compartment is mounted on the at least one rear structural member; a first inlet fluid passage/channel of the thermal management system is positioned on the at least one top structural member, wherein the first inlet fluid passage/channel comprises an inlet located on a rear portion of the at least one top structural member; a second inlet fluid passage/channel of the thermal management system is positioned on the at least one bottom structural member, wherein the second inlet fluid passage/channel comprises an inlet located on a bottom portion of the at least one front structural member; and the at least one outlet fluid passage/channel positioned rearward with respect to the compartment and below the top support member of the rider supporting structure, wherein the first inlet fluid passage/channel and the second inlet fluid passage/channel are adapted to allow a flow of fluid from the ambient environment towards the at least one energy unit compartment, and the at least one outlet fluid passage/channel is adapted to egress the flow of fluid flowing through a rear end of the vehicle.

In another embodiment, the at least one energy unit compartment is mounted on the at least one rear structural member; an inlet fluid passage/channel of the thermal management system is positioned on the at least one top structural member, wherein the inlet fluid passage/channel comprises an inlet located on a top portion of the at least one front structural member; and the at least one outlet fluid passage/channel positioned rearward with respect to the compartment and below the top support member of the rider supporting structure, wherein the inlet fluid passage/channel is adapted to allow a flow of fluid from the ambient environment towards the at least one energy unit compartment, and the at least one outlet fluid passage/channel is adapted to egress the flow of fluid flowing through a rear end of the vehicle.

In another embodiment, the at least one energy unit compartment is mounted on the at least one front structural member; an inlet fluid passage/channel of the thermal management system is positioned on the at least one front structural member, wherein the inlet fluid passage/channel comprises an inlet located on a front portion of the at least one top structural member and an outlet located on a front portion of the at least one bottom structural member; and wherein the inlet fluid passage/channel is adapted to allow a flow of fluid through the inlet towards the at least one energy unit compartment and allow egress the flow of fluid through the outlet.

In another embodiment, the at least one energy unit compartment is mounted on the at least one front structural member; an inlet fluid passage/channel of the thermal management system is positioned on the at least one front structural member, wherein the inlet fluid passage/channel comprises an inlet located on a front portion of the at least one bottom structural member and an outlet located on a front portion of the at least one top structural member; and wherein the inlet fluid passage/channel is adapted to allow a flow of fluid through the inlet towards the at least one energy unit compartment and allow egress the flow of fluid through the outlet.

In another embodiment, the at least one energy unit compartment is mounted on the at least one bottom structural member; an inlet fluid passage/channel of the thermal management system is positioned on the at least one bottom structural member, wherein the inlet fluid passage/channel comprises an inlet located on a top portion, and an outlet located on a bottom portion of the at least one rear structural member; and wherein the inlet fluid passage/channel is adapted to allow a flow of fluid through the inlet towards the at least one energy unit compartment and allow egress the flow of fluid through the outlet.

In another embodiment, a first energy unit compartment is mounted on the at least one rear structural member; a second energy unit compartment is mounted on the at least one bottom structural member; a first inlet fluid passage/channel of the thermal management system is positioned on the at least one top structural member, wherein the first inlet fluid passage/channel comprises an inlet located on a top portion of the at least one front structural member; a second inlet fluid passage/channel of the thermal management system is positioned on the at least one bottom structural member, wherein the second inlet fluid passage/channel comprises an inlet located on a bottom portion of the at least one front structural member; and the at least one outlet fluid passage/channel positioned rearward with respect to the compartment and below the top support member of the rider supporting structure, wherein the first inlet fluid passage/channel and the second inlet fluid passage/channel are adapted to allow a flow of fluid from the ambient environment towards the at least one energy unit compartment, and the at least one outlet fluid passage/channel is adapted to egress the flow of fluid flowing through a rear end of the vehicle.

In another embodiment, the at least one energy unit compartment is positioned within the compartment of the frame, wherein the at least one energy unit compartment comprises a plurality of energy units distributed within the compartment in a manner that gaps are defined between the plurality of energy units; an inlet located on an intermediate portion of the at least one front structural member, wherein the inlet is adapted to allow a flow of fluid towards the at least one energy unit compartment accommodated within the compartment; an outlet located on the at least one rear structural member and adapted to allow egress of the flow of fluid from a rear end of the vehicle, wherein the flow of fluid entering through the inlet is distributed within the gaps defined between the plurality of energy units.

In one exemplary embodiment, a vehicle may include a forced induction arrangement of fluid for thermal management to maintain a temperature of the at least one energy unit compartment. The forced induction arrangement may include a pump that may be incorporated along a preferred location of the vehicle. The pump may be used for forced induction of fluid to force fluid into the fluid passage/channel and/or to energy unit compartment. Further, a venturi at the one or more inlet fluid passage/channels may be configured by a preferred arrangement to increase the velocity of fluid entering therein supplied via the pump.

In one embodiment, the vehicle may incorporate a radiator being located in the front of the vehicle for a ram fluid cooling. In one embodiment, the radiator may be disposed along a front portion of the vehicle to be in direct contact with atmospheric fluid. The radiator may include conduits carrying fluid along the at least one energy unit compartment. The fluid may be configured to absorb the heat of the at least one energy unit compartment. Further, the heated fluid may be cooled in the radiator by the atmospheric fluid

These and other aspects and features of non-limiting embodiments of the present disclosure will become apparent to those skilled in the art upon review of the following description of specific non-limiting embodiments of the disclosure in conjunction with the accompanying drawings.

### BRIEF DESCRIPTION OF THE DRAWINGS

A better understanding of embodiments of the present disclosure (including alternatives and/or variations thereof) may be obtained with reference to the detailed description of the embodiments along with the following drawings, in which:

FIG. 1 illustrates a side view of an exemplary vehicle, according to an embodiment of the present disclosure;

FIG. 2 illustrates a side view of an exemplary vehicle, according to an embodiment of the present disclosure;

FIG. 3 illustrates an exemplary vehicle, according to an embodiment of the present disclosure;

FIG. 4 illustrates an exemplary vehicle, according to an embodiment of the present disclosure;

FIG. 5 illustrates an exemplary vehicle, according to an embodiment of the present disclosure;

FIG. 6 illustrates an exemplary vehicle, according to an embodiment of the present disclosure;

FIG. 7 illustrates an exemplary vehicle, according to an embodiment of the present disclosure;

FIG. 8 illustrates an exemplary vehicle, according to an embodiment of the present disclosure;

FIG. 9 illustrates an exemplary vehicle, according to an embodiment of the present disclosure;

FIG. 10 illustrates an exemplary vehicle, according to an embodiment of the present disclosure;

FIG. 11 illustrates an exemplary vehicle, according to an embodiment of the present disclosure;

FIG. 12 illustrates an exemplary vehicle, according to an embodiment of the present disclosure;

FIG. 13 illustrates an exemplary vehicle, according to an embodiment of the present disclosure;

FIG. 14 illustrates an exemplary vehicle, according to an embodiment of the present disclosure;

FIG. 15 illustrates an exemplary vehicle, according to an embodiment of the present disclosure;

FIG. 16 illustrates an exemplary vehicle, according to an embodiment of the present disclosure; and

FIG. 17 illustrates an exemplary vehicle having a forced induction of fluid, according to an embodiment of the present disclosure.

### DETAILED DESCRIPTION

The detailed description of various exemplary embodiments of the present invention is described herein with reference to the accompanying drawings. It should be noted that the embodiments are described herein in such details as to clearly communicate the present invention. However, the number of details provided herein is not intended to limit the anticipated variations of embodiments; on the contrary, the intention is to cover all modifications, equivalents, and alternatives falling within the spirit and scope of the present invention as defined by the appended claims.

It is also to be understood that various arrangements may be devised that, although not explicitly described or shown herein, embody the principles of the present invention. Moreover, all statements herein reciting principles, aspects, and embodiments of the present invention, as well as specific examples, are intended to encompass equivalents thereof.

While the embodiments of this susceptible to various modifications and alternative forms, specific embodiment thereof has been shown by way of example in the drawings and will be described in detail below. It should be understood, however that it is not intended to limit the present invention to the forms disclosed, but on the contrary, the present invention is to cover all modifications, equivalents, and alternatives falling within the scope of the present invention.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprise”, “comprising”, “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical, and other changes may be made without departing from the scope of the embodiments. The following detailed description is therefore not to be taken in a limiting sense.

The various embodiments of the invention provide a vehicle having a frame and a fluid distribution system. The fluid distribution system of the vehicle, is configured to communicate fluid, for example air or liquid, to an energy unit compartment having energy units. The fluid communicated to the energy unit compartment facilitates cooling of the energy unit. The frame of the vehicle defines a load carrying space, which also stores energy units and which efficiently cools these energy units using naturally flowing fluid through the frame. The fluid distribution system of the disclosure provides efficient fluid flow management for effective thermal management of energy units and electronics which are provided in the frame.

Further the load carrying space defines in the frame in such a manner that the centre of gravity be located within a defined zone whereby there is no wobbling or misbalancing of the vehicle when the vehicle it is being ridden. Accordingly, there is ease and safety in maneuverability of the vehicle and there is no learning curve involved in handling or riding.

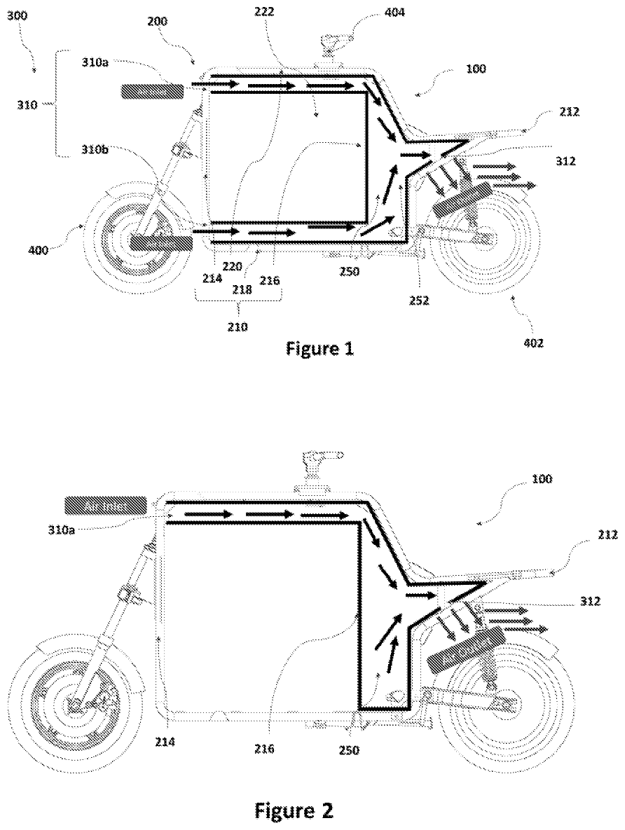

FIG. 1 illustrates a side view of a vehicle 100, according to this invention. The vehicle 100 includes a frame 200 having a plurality of structural elements 210 coupled with each other. The plurality of structural elements 210 are coupled to define a compartment 222 adapted to accommodate a cargo. The compartment 222 is adapted to accommodate a cargo, herein after referred as a cargo hold structure 222.

The plurality of structural elements 210 include a front lateral frame member 214, a rear lateral frame member 216, a bottom frame member 218, and a top frame member 220. The front lateral frame member 214, the rear lateral frame member 216, the bottom frame member 218, and the top frame member 220 are joined together to form the cargo hold structure 222. The frame 200 further includes a rider support structure 212. The rider support structure 212 is positioned rearward with respect to the compartment 222.

The vehicle 100 further includes an energy unit compartment 250. The energy unit compartment 250 is positioned on one of the plurality of structural elements 210. In accordance with the embodiment illustrated in FIG. 1, the energy unit compartment 250 is located at the rear lateral frame member 216 of the cargo hold structure 222. The energy unit compartment 250 houses at least one energy unit 252. The at least one energy unit 252 includes energy generation/storage unit, for example, battery or fuel cell and so forth. Alternatively, the energy unit 252 may include one or more supercapacitor (also called an ultracapacitor). Further, the energy unit compartment 250 may house one or more electronic circuits related to at least one energy unit 252.

The vehicle 100 further includes a thermal management system 300 adapted to maintain a temperature of the at least one energy unit 252. The thermal management system 300 includes one or more inlet fluid passage/channels 310 and at least one outlet fluid passage/channel 312. The one or more inlet fluid passage/channels 310 are mounted on at least one of the plurality of structural elements 210. In an embodiment, one or more inlet fluid passage/channels 310 are mounted at the front lateral frame member 214 of the cargo hold structure 222. The one or more inlet fluid passage/channels 310 allows a flow of fluid, for example air, from the ambient environment towards the energy unit compartment 250 and allows thermal dissipation of heat generated by the at least one energy unit 252. In addition, the flow of fluid from the ambient environment may cool the one or more electronic circuits housed within the energy unit compartment 250.

As shown in FIG. 1, the one or more inlet fluid passage/channels 310 include fluid passage/channel 310a and fluid passage/channel 310b. In at least an embodiment, the fluid passage/channel 310a, according to this configuration, is disposed at an operative top position of the front lateral frame member 214 of the cargo hold structure 222.

The fluid passage/channel 310b, according to this configuration, as disclosed in the accompanying FIG. 1, is disposed at an operative bottom position of the front lateral frame member 214 of the cargo hold structure 222.

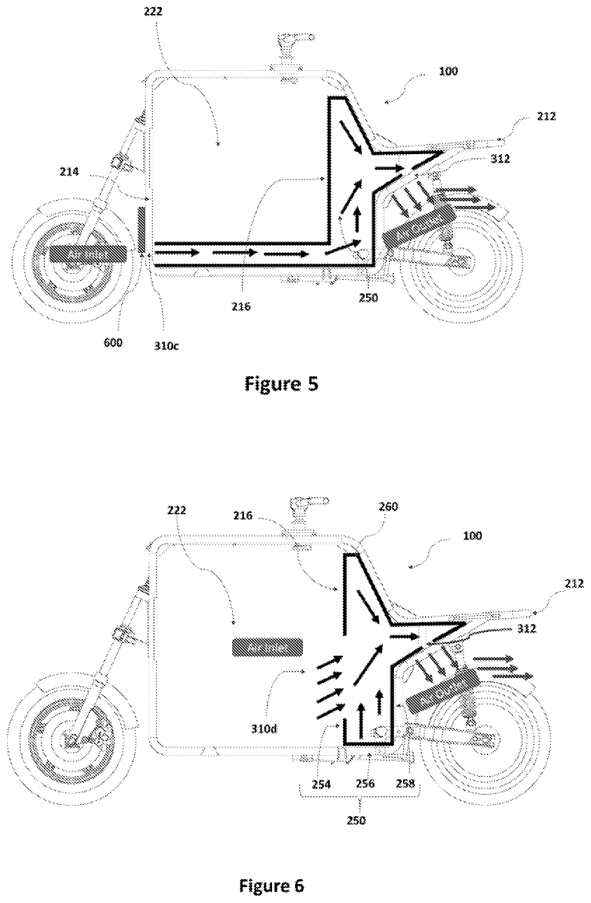

In at least an embodiment, according to FIG. 1, the at least one outlet fluid passage/channel 312 is provided at the rear lateral frame member 216 of the cargo hold structure 222. The at least one outlet fluid passage/channel 312 is channeled towards the rider support structure 212 and allows egress of the fluid from below the rider support structure 212. In one embodiment, the vehicle 100 may incorporate a radiator 600 being located in the front of the vehicle 100 for a ram fluid cooling, as can be seen in FIG. 5. In one embodiment, the radiator 600 may be disposed along a front portion of the vehicle 100 to be in direct contact with atmospheric fluid. The radiator may include conduits carrying fluid along the at least one energy unit compartment. The fluid may be configured to absorb the heat of the at least one energy unit compartment. Further, the heated fluid may be cooled in the radiator 600 by the atmospheric fluid.

In at least an embodiment, according to FIG. 1, the vehicle 100 further comprises at least one front wheel 400 and at least one rear wheel 402. The at least one front wheel is operatively coupled along the front lateral frame member 214. The at least one rear wheel is operatively coupled along the bottom of rider supporting structure 212 and the rear lateral frame member 216. The vehicle 100 comprises a handlebar 404 operatively coupled to the top member 220 of the cargo hold structure 222. The handlebar 404 is operatively coupled with the at least one front wheel 400 and enables steering of the vehicle 100 allowing control of a direction of traversing of the vehicle 100. In one embodiment, the rider supporting structure 212 may also include a pillion support extending therefrom.

FIG. 2 illustrates the side view of the vehicle 100. The energy unit compartment 250 of the vehicle 100 is located at the rear lateral frame member 216 of the cargo hold structure 222. The thermal management system 300 of the vehicle 100, comprising the fluid inlet fluid passage/channel 310a, at the front lateral frame member 214 of the cargo hold structure 222.

In at least an embodiment, the inlet fluid passage/channel 310a, according to the configuration, as disclosed in FIG. 2, is disposed at an operative top position of the front lateral frame member 214 of the cargo hold structure 222.

In at least an embodiment, according to FIG. 2, the at least one outlet fluid passage/channel 312 is provided at the rear lateral frame member 216 of the cargo hold structure 222. The at least one outlet fluid passage/channel 312 is channeled towards the rider support structure 212 and allows egress of the fluid from below the rider support structure 212.

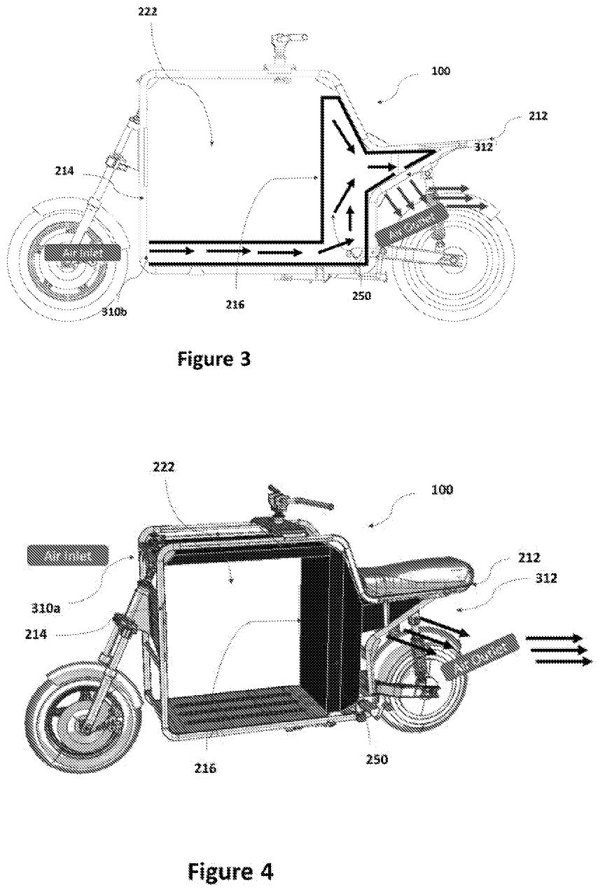

FIG. 3 illustrates the side view of the vehicle 100. The energy unit compartment 250 of the vehicle 100 is located at the rear lateral frame member 216 of the cargo hold structure 222. The thermal management system 300 of the vehicle includes the fluid inlet fluid passage/channel 310b, at the front lateral frame member 214 of the cargo hold structure 222.

In at least an embodiment, the inlet fluid passage/channel 310b, according to the configuration, as disclosed in the accompanying FIG. 3, is disposed at an operative bottom of the front lateral frame member 214 of the cargo hold structure 222.

In at least an embodiment, according to FIG. 3, the at least one outlet fluid passage/channel 312 is provided at the rear lateral frame member 216 of the cargo hold structure 222. The at least one outlet fluid passage/channel 312 is channeled towards the rider support structure 212 and allows egress of the fluid from below the rider support structure 212.

FIG. 4 illustrates the side view of the vehicle 100, according to this invention. The energy unit compartment 250 of the vehicle 100 is located at the rear lateral frame member 216 of the cargo hold structure 222. The thermal management system 300 of the vehicle 100 includes the fluid inlet fluid passage/channel 310a, at the front lateral frame member 214 of the cargo hold structure 222.

In at least an embodiment, the inlet fluid passage/channel 310a, according to the configuration, as disclosed in the accompanying FIG. 4, is disposed at an operative top of the front lateral frame member 214 of the cargo hold structure 222.

In at least an embodiment, according to FIG. 4, the at least one outlet fluid passage/channel 312 is provided at the rear lateral frame member 216 of the cargo hold structure 222. The at least one outlet fluid passage/channel 312 is channeled towards the rider support structure 212 and allows egress of the fluid from below the rider support structure 212.

FIG. 6 illustrates the side view of the vehicle 100. The energy unit compartment 250 of the vehicle 100 is located at the rear lateral frame member 216 of the cargo hold structure 222. The energy unit compartment 250 includes one or more sides 254, a bottom surface 256, a rear surface 258 and a top surface 260. According to FIG. 6, the one or more inlet fluid passage/channels 310 of the thermal management system 300 includes a fluid inlet fluid passage/channel 310d, disposed along the one or more sides 254 of the energy unit compartment 250.

In at least an embodiment, according to FIG. 6, the at least one outlet fluid passage/channel 312 is provided at the rear lateral frame member 216 of the cargo hold structure 222. The at least one outlet fluid passage/channel 312 is channeled towards the rider support structure 212 and allows egress of the fluid from below the rider support structure 212.

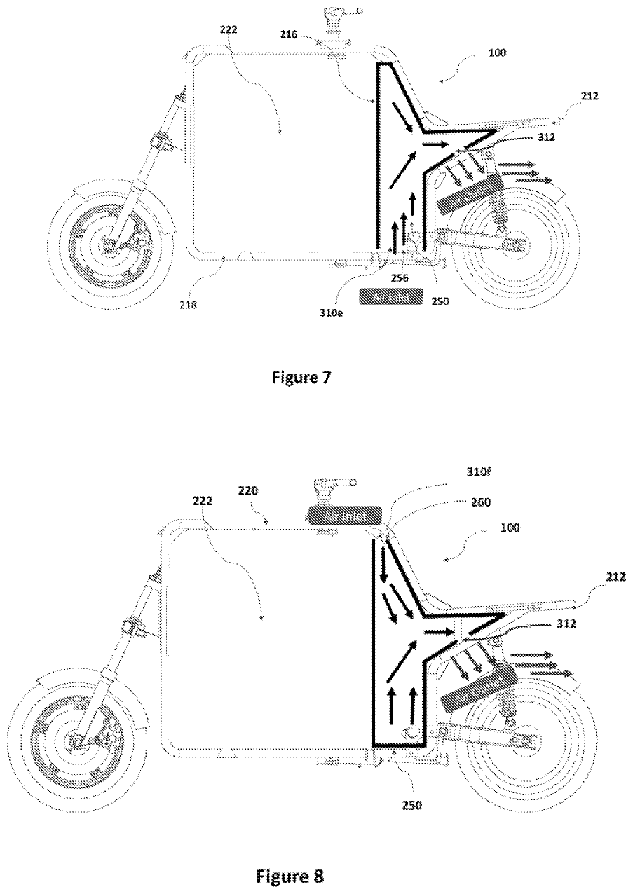

FIG. 7 illustrates the side view of the vehicle 100. The energy unit compartment 250 of the vehicle 100 is located at the rear lateral frame member 216 of the cargo hold structure 222. The one or more inlet fluid passage/channels 310 of the thermal management system 300 of the vehicle 100, according to FIG. 7, includes a fluid inlet fluid passage/channel 310e, disposed at the bottom surface 256 of the energy unit compartment 250. More specifically, the fluid inlet fluid passage/channel 310e is disposed at the bottom frame member 218 below the bottom surface 256 of the energy unit compartment 250.

In at least an embodiment, according to FIG. 7, the at least one outlet fluid passage/channel 312 is provided at the rear lateral frame member 216 of the cargo hold structure 222. The at least one outlet fluid passage/channel 312 is channeled towards the rider support structure 212 and allows egress of the fluid from below the rider support structure 212.

FIG. 8 illustrates the side view of the vehicle 100. The energy unit compartment 250 of the vehicle 100 is located at the rear lateral frame member 216 of the cargo hold structure 222. The one or more inlet fluid passage/channels 310 of the thermal management system 300, according to FIG. 8, includes a fluid inlet fluid passage/channel 310f, disposed at the top surface 260 of the energy unit compartment 250. More specifically, the fluid inlet fluid passage/channel 310f is disposed at the top frame member 220 above the top surface 260 of the energy unit compartment 250.

In at least an embodiment, according to FIG. 8, the at least one outlet fluid passage/channel 312 is provided at the rear lateral frame member 216 of the cargo hold structure 222. The at least one outlet fluid passage/channel 312 is channeled towards the rider support structure 212 and allows egress of the fluid from below the rider support structure 212.

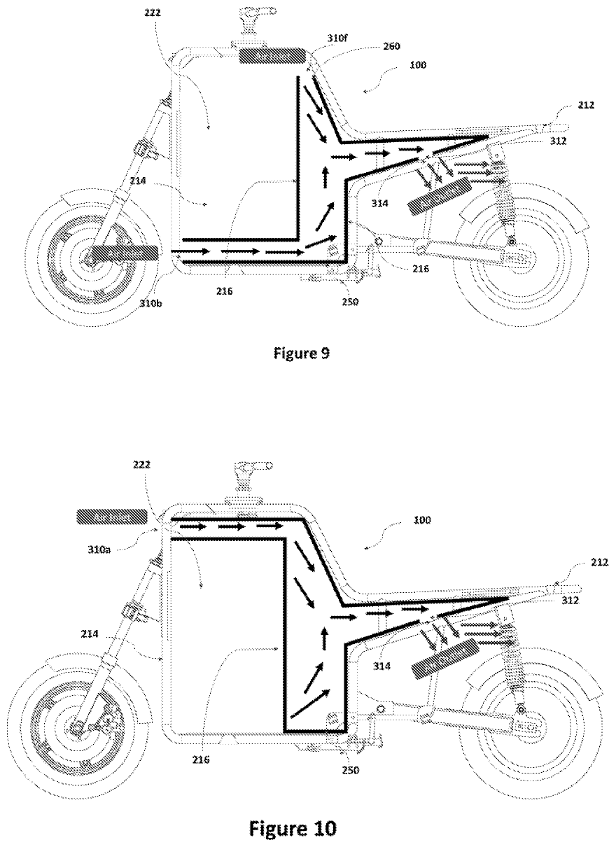

FIG. 9 illustrates the side view of the vehicle 100. The energy unit compartment 250 of the vehicle 100 is located at the rear lateral frame member 216 of the cargo hold structure 222. According to the FIG. 9, the thermal management system 300 includes the fluid inlet fluid passage/channel 310b and the fluid inlet fluid passage/channel 310f.

In at least an embodiment, the inlet fluid passage/channel 310f, according to this configuration, as disclosed in the accompanying FIG. 9, is disposed at the top frame member 220 near the top surface 260 of the energy unit compartment 250.

In at least an embodiment, the inlet fluid passage/channel 310b, according to this configuration, as disclosed in the accompanying FIG. 9, is disposed at the bottom of the front lateral frame member 214 of the cargo hold structure 222.

In at least an embodiment, according to FIG. 9, the at least one outlet fluid passage/channel 312 is provided at the rear lateral frame member 216 of the cargo hold structure 222. The at least one outlet fluid passage/channel 312 is channeled towards the rider support structure 212 and allows egress of the fluid from below the rider support structure 212. According to FIG. 9, the at least one outlet fluid passage/channel 312 includes an electric fan 314 for actively draw the fluid from the ambient environment or to actively exhaust the fluid from the thermal management system 300.

FIG. 10 illustrates the side view of the vehicle 100. The energy unit compartment 250 of the vehicle 100 is located at the rear lateral frame member 216 of the cargo hold structure 222. According to the FIG. 10, the thermal management system 300 includes the fluid inlet fluid passage/channel 310a, at the operative top position of the front lateral frame member 214 of the cargo hold structure 222.

In at least an embodiment, according to FIG. 10, the at least one outlet fluid passage/channel 312 is provided at the rear lateral frame member 216 of the cargo hold structure 222. The at least one outlet fluid passage/channel 312 is channeled towards the rider support structure 212 and allows egress of the fluid from below the rider support structure 212. According to FIGS. 9 and 10, the at least one outlet fluid passage/channel 312 includes an electric fan 314 for actively draw the fluid from the ambient environment or to actively exhaust the fluid from the thermal management system 300.

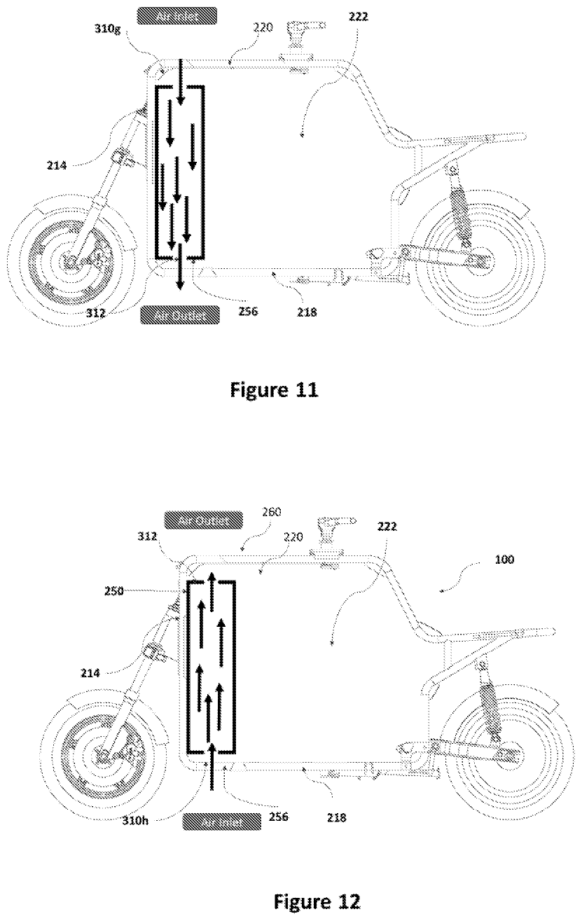

FIG. 11 illustrates the side view of the vehicle 100. The energy unit compartment of the vehicle located at the front lateral frame member 214 of the cargo hold structure 222. The one or more inlet fluid passage/channels 310 of the thermal management system 300 of the vehicle 100, according to FIG. 11, includes a fluid inlet fluid passage/channel 310g. The inlet fluid passage/channel 310g is disposed at an operative top portion of the top surface 260 of the Energy unit compartment 250. More specifically, the fluid inlet fluid passage/channel 310g is disposed at the top portion of the top frame member 220, directly above the top surface 260 of the energy unit compartment 250.

In at least an embodiment, according to FIG. 11, the at least one outlet fluid passage/channel 312 is provided at the operative bottom portion of the bottom frame member 218. In one embodiment, such at least one outlet fluid passage/channel 312 may be directly below the bottom surface 256 of the energy unit compartment 250. In another embodiment, such at least one outlet fluid passage/channel 312 may directly be above the bottom surface 256 of the energy unit compartment 250. In further embodiments, such at least one outlet fluid passage/channel 312 may be aligned at the same height as of the bottom surface 256 of the energy unit compartment 250.

FIG. 12 illustrates side vide of the vehicle 100. The energy unit compartment 250 is located at the front lateral frame member 214 of the cargo hold structure 222. The one or more inlet fluid passage/channels 310 of the thermal management system 300 of the vehicle 100, according to FIG. 12, includes a fluid inlet fluid passage/channel 310h. The fluid inlet fluid passage/channel 310h is disposed at the operative bottom portion of the bottom frame member 218. In one embodiment, such fluid inlet passage/channel 310h may be directly below the bottom surface 256 of the energy unit compartment 250. In one embodiment, such fluid inlet passage/channel 310h may directly be above the bottom surface 256 of the energy unit compartment 250. In further embodiments, such fluid inlet passage/channel 310h may be aligned as the same height at of the bottom surface 256 of the energy unit compartment 250.

In at least an embodiment, according to FIG. 12, the at least one outlet fluid passage/channel 312 is provided at the top portion of the top frame member 220. In one embodiment, such outlet fluid passage/channel 312 may directly be above the top surface 260 of the energy unit compartment 250. In one embodiment, such fluid inlet passage/channel 312 may directly be below the top surface 260 of the energy unit compartment 250. In further embodiments, such fluid inlet passage/channel 312 may be aligned at the same height as of the bottom surface 256 of the energy unit compartment 250.

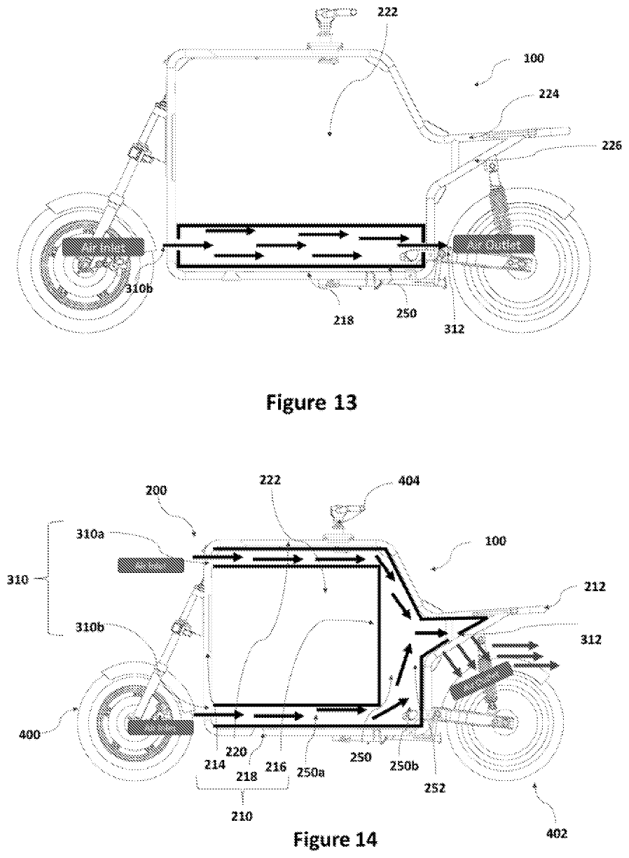

FIG. 13 illustrates side vide of the vehicle 100. The energy unit compartment 250 is located at the bottom frame member 218 of the cargo hold structure 222. The thermal management system 300 of the vehicle 100 includes the fluid inlet fluid passage/channel 310. The fluid inlet fluid passage/channel 310 is disposed at an operative bottom portion of the front lateral frame member 214 of the cargo hold structure 222.

In at least an embodiment, according to FIG. 13, the at least one outlet fluid passage/channel 312 is provided at the operative bottom portion of the rear lateral frame member 216.

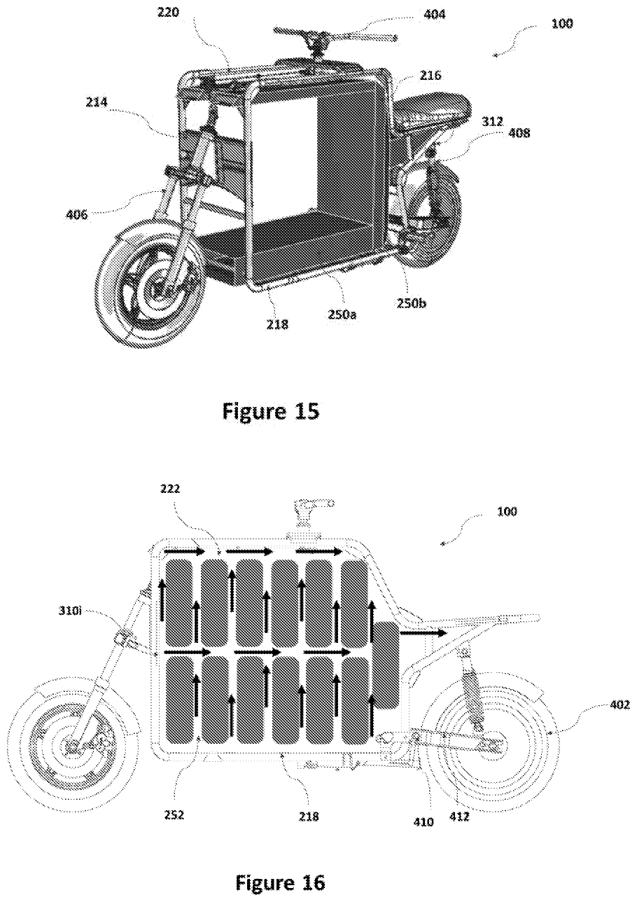

FIGS. 14 and 15 illustrate side vide of the vehicle 100. The vehicle 100, according to at least an embodiment of FIGS. 14 and 15, comprises at least two energy unit compartments 250a and 250b. The energy unit compartment 250a is located at the bottom frame member 218 of the cargo hold structure 222. The energy unit compartment 250b of the vehicle 100 is located at the rear lateral frame member 216 of the cargo hold structure 222. The thermal management system 300 of the vehicle 100, comprising the fluid inlet fluid passage/channel 310a and 310b at the front lateral frame member 214 of the cargo hold structure 222. The inlet fluid passage/channel 310a is disposed at an operative top position of the front lateral frame member 214 of the cargo hold structure 222. The inlet fluid passage/channel 310b is disposed at an operative bottom position of the front lateral frame member 214 of the cargo hold structure 222.

In at least an embodiment, according to FIGS. 14 and 15, the at least one outlet fluid passage/channel 312 is provided at the rear lateral frame member 216 of the cargo hold structure 222. The at least one outlet fluid passage/channel 312 is channeled towards the rider support structure 212 and allows egress of the fluid from below the rider support structure 212.

FIG. 15 further illustrates a front suspension unit 406 and a rear suspension unit 408. The handlebar 404 is mounted on the at least one the top frame member 220 of the cargo hold structure 222. A vertical axis of the handlebar 404 is spaced apart from a vertical central axis of the compartment (not shown). A horizontal axis of the handlebar 404 is collinear with the horizontal axis of the front suspension unit 406.

FIG. 16 illustrates side view of the vehicle 100. The cargo hold structure 222 of the vehicle 100, houses multiple energy unit units 252. The one or more inlet fluid passage/channels 310 of the thermal management system 300 of the vehicle 100, according to FIG. 16, includes one or more fluid inlet fluid passage/channel 310i. The inlet fluid passage/channel 310i may be disposed at an operative middle portion of the front lateral frame member 214 of the cargo hold structure 222.

In accordance with an embodiment of the present disclosure, spaces are provided between different energy unit units 252 in the cargo hold structure 222. The spaces are spaced apart and allow flow of the intake fluid from the inlet fluid passage/channel 310i from the spaces allowing thermal dissipation from each of the multiple energy unit units 252. Alternatively, the spaces between different energy units 252 contains a cooling medium such as oil, water, refrigerant gas, heat pipes etc. As such, cooling mechanism may be liquid cooling type, radiator-assisted cooling type, and/or water jacket cooling type. In an example, thermally conductive polymer may be provided, for cooling.

The cooling medium transfers heat from the different energy units 252 to at least one heat sink or the radiator 600 (active cooling system), as seen in FIG. 5. The fluid inlet fluid passage/channel 310i, as seen in FIG. 16, is configured to direct the intake fluid towards the at least one heat sink or the radiator for thermal dissipation from the at least one heat sink or the radiator, effectively removing heat generated by the multiple energy units 252. In at least an embodiment, each of the plurality of structural elements 210 of the vehicle 100 includes channels or fluid passage/channels configured to aid in laminar flow of fluid.

In at least an embodiment, according to FIG. 16, the at least one outlet fluid passage/channel 312 is provided at the rear lateral frame member 216 of the cargo hold structure 222. The at least one outlet fluid passage/channel 312 is channeled towards the rider support structure 212 and allows egress of the fluid from below the rider support structure 212.

FIG. 16 further illustrates a swing arm pivot 410 for mounting a swing arm 412. The swing arm pivot 410 is disposed at the rear lateral frame member 216. A distal end of the swing arm 412 provides support for the axel of at least one rear wheel 402.

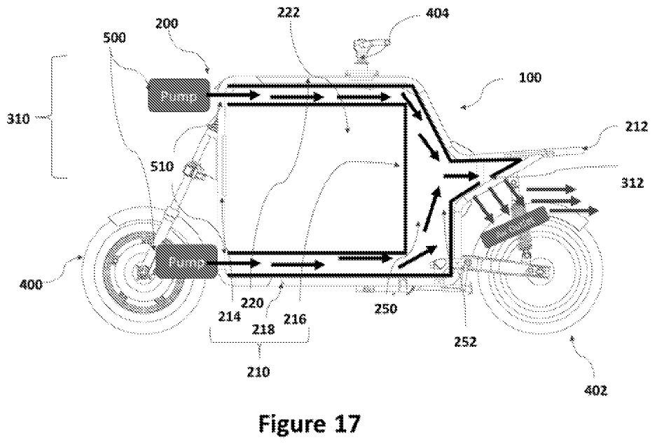

Referring now to FIG. 17, an exemplary vehicle having a forced induction arrangement of fluid for thermal management to maintain a temperature of the at least one energy unit compartment 250 is illustrated, according to an embodiment of the present disclosure. The forced induction arrangement may include a pump 500 that may be incorporated along a preferred location of the vehicle 100. The plurality of structural elements 210 include a front lateral frame member 214, a rear lateral frame member 216, a bottom frame member 218, and a top frame member 220 The pump 500 may be used for forced induction of fluid to force fluid into the fluid passage/channel 312 and/or to energy unit compartment 250. Further, a venturi 510 at the one or more inlet fluid passage/channels 310 may be configured by a preferred arrangement to increase the velocity of fluid entering therein supplied via the pump 500. The preferred location for incorporation of the pump 500 and the venturi 510 may be along the frame 200 including the plurality of structural elements 210 having the front lateral frame member 214, the rear lateral frame member 216, the bottom frame member 218, and the top frame member 220.

### INDUSTRIAL APPLICABILITY

The present disclosure is related to the vehicle 100 that provides a better solution for the last mile delivery which has hitherto been carried out using existing scooters or motorcycles which are not functionally and ergonomically designed for the last mile delivery. The vehicle 100 is specifically designed to carry cargo so that users can conveniently transport items such as groceries, children, food deliveries, warehouse items, etc. At the same time, the vehicle 100 offers more utility for local transportation needs, at far less cost, with less maintenance than existing bicycles, tricycles, and kick scooters. The vehicle 100 has the cargo hold structure 222 ahead of its rider. Further, the vehicle 100 has the energy unit compartment 250 ahead of the rider. The thermal management system 300 effectively introduces ram fluid (fluid) and guides it through plurality of structural elements 210, and further directs it deftly to the energy unit component 250 before being finally discharged, upon dissipation of heat, in a laminar fluid flow manner.

The frame 200 of the vehicle 100 is designed to maintain centre of gravity of the vehicle 100, especially after addition of cargo, along with an energy unit component such as a battery, and rider, relatively lower (closer to ground) and substantially on or very near to the centerline of the wheelbase of the vehicle 100.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

Although the embodiments herein are described with various specific embodiments, it will be obvious for a person skilled in the art to practice the embodiments herein with modifications. Although the embodiments herein are described with various specific embodiments, it will be obvious for a person skilled in the art to practice the embodiments herein with modifications.

The scope of the embodiments of the present invention is to be ascertained with the claims to submitted at the time of filing the complete specification.

What is claimed is:

1. A vehicle comprising:
a frame comprising a plurality of structural elements coupled with each other to define a compartment adapted to accommodate a cargo;
at least one energy unit compartment positioned on one of the plurality of structural elements, the at least one energy unit compartment adapted to accommodate at least energy unit; and
a thermal management system adapted to maintain a temperature of the at least one energy unit compartment, wherein the thermal management system comprising:
at least one inlet fluid passage/channel mounted on at least one of the plurality of structural elements and adapted to allow a flow of fluid from the ambient environment towards the at least one energy unit compartment, wherein the at least one energy unit compartment is exposed to the flow of fluid entering through the at least one inlet fluid passage/channel; and
at least one outlet fluid passage/channel mounted on at least one of the plurality of structural elements and positioned downstream with respect to the at least one energy unit compartment, wherein the at least one outlet fluid passage/channel is adapted to allow egress of the flow of fluid from the vehicle.

2. The vehicle as claimed in claim 1, wherein the frame comprises a rider supporting structure positioned rearward with respect to the compartment, the rider supporting structure is adapted to be operatively coupled with a rear wheel of the vehicle,
wherein the rider supporting structure comprises at a top support member, and a bottom support member, wherein the top support member is adapted to hold a rider of the vehicle, and
the top support member is positioned at a height with respect to the compartment in manner that a centre of gravity of the rider remains higher than a centre of gravity of the cargo held in the compartment.

3. The vehicle as claimed in claim 1, wherein the plurality of structural elements comprises at least one front structural member, at least one rear structural member, at least one bottom structural member, and at least one top structural member.

4. The vehicle as claimed in claim 1 further comprising a handlebar adapted to be operated to control a direction of traversing of the vehicle, wherein the handlebar is positioned longitudinally spaced apart from a steering axis of the vehicle.

5. The vehicle as claimed in any of claims 3 and 4, wherein the handlebar is mounted on the at least one top structural member of the frame, wherein a vertical axis of the handlebar is spaced apart from a vertical central axis of the compartment.

6. The vehicle as claimed in any of claims 1 and 3, wherein:
the at least one energy unit compartment is mounted on the at least one rear structural member;
a first inlet fluid passage/channel of the thermal management system is positioned on the at least one top structural member, the first inlet fluid passage/channel comprises an inlet located at a front end of the vehicle;
a second inlet fluid passage/channel of the thermal management system is positioned on the at least one bottom structural member, the second inlet fluid passage/channel comprises an inlet located at a front end of the vehicle; and
the at least one outlet fluid passage/channel positioned rearward with respect to the compartment and below the top support member of the rider supporting structure,
wherein the first inlet fluid passage/channel and the second inlet fluid passage/channel are adapted to allow a flow of fluid through a front end of the vehicle towards the at least one energy unit compartment, and the at least one outlet fluid passage/channel is adapted to egress the flow of fluid flowing through a rear end of the vehicle.

7. The vehicle as claimed in any of claims 1 and 3, wherein:
the at least one energy unit compartment is mounted on the at least one rear structural member;
an inlet fluid passage/channel of the thermal management system is positioned on the at least one top structural member or positioned on the at least one bottom structural member, the inlet fluid passage/channel comprises an inlet located at a front end of the vehicle; and
the at least one outlet fluid passage/channel positioned rearward with respect to the compartment and below the top support member of the rider supporting structure,
wherein the inlet fluid passage/channel is adapted to allow a flow of fluid from the ambient environment through a front end of the vehicle towards the at least one energy unit compartment, and the at least one outlet fluid passage/channel is adapted to egress the flow of fluid flowing through a rear end of the vehicle.

8. The vehicle as claimed in any of claims 1 and 3, wherein:
the at least one energy unit compartment is mounted on the at least one rear structural member;
an inlet fluid passage/channel of the thermal management system is positioned on the at least one rear structural member; and
the at least one outlet fluid passage/channel positioned rearward with respect to the compartment and below the top support member of the rider supporting structure,
wherein the inlet fluid passage/channel is adapted to allow a flow of fluid from the ambient environment towards the at least one energy unit compartment, and the at least one outlet fluid passage/channel is adapted to egress the flow of fluid flowing through a rear end of the vehicle.

9. The vehicle as claimed in any of claims 1 and 3, wherein:
the at least one energy unit compartment is mounted on the at least one rear structural member;
an inlet fluid passage/channel of the thermal management system is positioned on the at least one bottom structural member or positioned on the at least one top structural member, wherein the inlet fluid passage/channel comprises an inlet located on a bottom portion or on a top portion; and
the at least one outlet fluid passage/channel positioned rearward with respect to the compartment and below the top support member of the rider supporting structure,
wherein the inlet fluid passage/channel is adapted to allow a flow of fluid from the ambient environment towards the at least one energy unit compartment, and the at least one outlet fluid passage/channel is adapted to egress the flow of fluid flowing through a rear end of the vehicle.

10. The vehicle as claimed in any of claims 1 and 3, wherein:
the at least one energy unit compartment is mounted on the at least one rear structural member;
a first inlet fluid passage/channel of the thermal management system is positioned on the at least one top structural member, wherein the first inlet fluid passage/channel comprises an inlet located on a rear portion of the at least one top structural member;
a second inlet fluid passage/channel of the thermal management system is positioned on the at least one bottom structural member, wherein the second inlet fluid passage/channel comprises an inlet located on a bottom portion of the at least one front structural member; and
the at least one outlet fluid passage/channel positioned rearward with respect to the compartment and below the top support member of the rider supporting structure,
wherein the first inlet fluid passage/channel and the second inlet fluid passage/channel are adapted to allow a flow of fluid from the ambient environment towards the at least one energy unit compartment, and the at least one outlet fluid passage/channel is adapted to egress the flow of fluid flowing through a rear end of the vehicle.

11. The vehicle as claimed in any of claims 1 and 3, wherein:
the at least one energy unit compartment is mounted on the at least one front structural member;
an inlet fluid passage/channel of the thermal management system is positioned on the at least one front structural member, wherein the inlet fluid passage/channel comprises an inlet located on a front portion of the at least one top structural member or the at least one bottom structural member, and an outlet located on a front portion of the at least one bottom structural member or the at least one top structural member; and
wherein the inlet fluid passage/channel is adapted to allow a flow of fluid through the inlet towards the at least one energy unit compartment and allow egress the flow of fluid through the outlet.

12. The vehicle as claimed in any of claims 1 and 3, wherein:
the at least one energy unit compartment is mounted on the at least one bottom structural member;
an inlet fluid passage/channel of the thermal management system is positioned on the at least one bottom structural member, wherein the inlet fluid passage/channel comprises an inlet located on a bottom portion of the at least one front structural member and an outlet located on a bottom portion of the at least one rear structural member; and
wherein the inlet fluid passage/channel is adapted to allow a flow of fluid through the inlet towards the at least one energy unit compartment and allow egress the flow of fluid through the outlet.

13. The vehicle as claimed in any of claims 1 and 3, wherein:
a first energy unit compartment is mounted on the at least one rear structural member;
a second energy unit compartment is mounted on the at least one bottom structural member;
a first inlet fluid passage/channel of the thermal management system is positioned on the at least one top structural member, wherein the first inlet fluid passage/channel comprises an inlet located on a top portion of the at least one front structural member;
a second inlet fluid passage/channel of the thermal management system is positioned on the at least one bottom structural member, wherein the second inlet fluid passage/channel comprises an inlet located on a bottom portion of the at least one front structural member; and
the at least one outlet fluid passage/channel positioned rearward with respect to the compartment and below the top support member of the rider supporting structure,
wherein the first inlet fluid passage/channel and the second inlet fluid passage/channel are adapted to allow a flow of fluid from the ambient environment towards the at least one energy unit compartment, and the at least one outlet fluid passage/channel is adapted to egress the flow of fluid flowing through a rear end of the vehicle.

14. The vehicle as claimed in any of claims 1 and 3, wherein:
the at least one energy unit compartment is positioned within the compartment of the frame, wherein the at least one energy unit compartment comprises a plurality of energy units distributed within the compartment in a manner that gaps are defined between the plurality of energy units;
an inlet located on an intermediate portion of the at least one front structural member, wherein the inlet is adapted to allow a flow of fluid towards the at least one energy unit compartment accommodated within the compartment;
an outlet located on the at least one rear structural member and adapted to allow egress of the flow of fluid from a rear end of the vehicle,
wherein the flow of fluid entering through the inlet is distributed within the gaps defined between the plurality of energy units.

15. The vehicle as claimed in any of claim 1 further comprising:
a forced cooling arrangement having:
a pump 500 incorporated along a preferred location of the vehicle 100; and
a venturi 510 at the one or more inlet fluid passage/channels 310 is formed by a preferred arrangement to increase the velocity of fluid entering therein via the help of the pump.

16. The vehicle as claimed in any of claim 1 further comprising:
a radiator disposed along a front portion of the vehicle to be in direct contact with atmospheric fluid, the radiator having conduits carrying fluid along the at least one energy unit compartment, wherein the fluid is configured to absorb the heat of the at least one energy unit compartment, and
wherein, the heated fluid is cooled in the radiator 600 by the atmospheric fluid.
